(19) United States
(12) Patent Application Publication
(10) Pub. No.: US 2024/0270661 A1
(43) Pub. Date: Aug. 15, 2024

(54) COATED GRANULAR SUBSTANCE, METHOD FOR COATING A GRANULAR SUBSTANCE AND USE OF A BINDER FOR COATING A GRANULAR SUBSTANCE

(71) Applicant: ASK CHEMICALS GMBH, Hilden (DE)

(72) Inventors: Christian PRIEBE, Wülfrath (DE); Jan KLESING, Essen (DE)

(21) Appl. No.: 18/569,919

(22) PCT Filed: Jun. 23, 2022
(86) PCT No.: PCT/EP2022/067150

§ 371 Date: Dec. 13, 2023

(30) Foreign Application Priority Data
Jun. 24, 2021 (DE) 10 2021 003 265.9

(51) Int. Cl. C05G 5/30; C05G 5/12

(52) U.S. Cl. CPC C05G 5/37; C05G 5/12

(57) ABSTRACT

The present invention relates to a coated granular substance, wherein the coating is obtained by curing a binder, wherein the binder comprises: one or more benzyl ether-type phenolic resins: an isocyanate formulation consisting of one or more isocyanate compounds having at least 2 isocyanate groups per molecule: wherein the binder is further characterized by one or both of the following features: a) the binder contains free phenol and free hydroxybenzyl alcohol, wherein at least about 1.2 parts by weight of free hydroxybenzyl alcohol per 1 part by weight of free phenol is contained in the binder: b) the binder contains free phenol and free saligenin (o-hydroxybenzyl alcohol), wherein at least about 1.1 parts by weight of free saligenin (o-hydroxy benzyl alcohol) per 1 part by weight of free phenol is contained in the binder: wherein the granular substance is selected from agrochemicals. Furthermore, the invention relates to a method for producing the coated granular substance and the use of the binder for coating a granular substance.

### TECHNICAL FIELD

The present invention relates to coated granular substances which can be used in agriculture. The invention also relates to a method for coating a granular substance and the use of a binder for coating a granular substance.

### STATE OF THE ART

WO 2018/113853 discloses binders for curing molding material mixtures containing a fire-resistant molding base material. The molding material mixtures can be used for the production of cores, molds or feeders for metal casting.

Granular, at least partially water-soluble substances coated with a water-insoluble but water-permeable layer are generally known. These substances have reached particular importance in the field of fertilizers, since the dissolution rate of the active ingredients can be controlled by the coating. In this way, it is possible to obtain long-term fertilizers having an effectiveness of several months.

As coating resins, various systems have been suggested. The following examples represent a small selection only.

DE 2 155 924 discloses phenol resols for coating granulated fertilizers.

In EP 0 230 601 and EP 1 451 129, 2-component polyurethane systems are used.

WO 2016/166100 describes curing by means of a spraying device wherein the catalyst is a hydroxyl group-containing amine with a comparatively high flash point. This avoids the use of ATEX equipment, which offers cost advantages.

DE 10 2015 107 016 teaches in Table 1 that the saligenin content of an exemplary benzyl ether resin of phenol and formaldehyde has a higher content of free phenol than saligenin (7.9%/6.2%; 7.7%/6.1%; 7.7%/6.1%; 7.6%/5.8%). The ratio of phenol to saligenin is always 1:<1.

### DESCRIPTION OF THE FIGURE

FIG. 1 shows the measurement of the conductivity in the leaching tests.

### OBJECT OF THE INVENTION

One object of the invention is to provide a binder with which agrochemicals can be coated.

Surprisingly it was found that the binder employed according to the invention shows a higher reactivity and also requires less or no amine dosing for complete curing.

A further object of the present invention is to provide a coated granular substance with a good release of the granular substance. Moreover, the aforementioned problems are to be overcome in the production of the coated granular substances. Another object is to provide a process for coating granular substances in which the curing of the coating takes place within a shorter period of time or with reduced amine dosing.

### DISCLOSURE OF THE INVENTION

The present invention relates to a coated granular substance, wherein the coating is obtained by curing a binder,
wherein the binder comprises:
   one or more benzyl ether-type phenolic resins;
   an isocyanate formulation consisting of one or more isocyanate compounds having at least 2 isocyanate groups per molecule;
wherein the binder is further characterized by one or both of the following features:
   a) the binder contains free phenol and free hydroxybenzyl alcohol, wherein at least about 1.2 parts by weight of free hydroxybenzyl alcohol per 1 part by weight of free phenol is contained in the binder;
   b) the binder contains free phenol and free saligenin (o-hydroxybenzyl alcohol), wherein at least about 1.1 parts by weight of free saligenin (o-hydroxybenzyl alcohol) per 1 part by weight of free phenol is contained in the binder;
wherein the granular substance is selected from agrochemicals.

A further aspect of the invention is a process for preparing a coated granular substance according to the invention, comprising the steps
(a) providing the granular substance;
(b) providing the one or more benzyl ether-type phenolic resin(s) the isocyanate formulation;
(c) optionally mixing the one or more benzyl ether type phenolic resin(s) with the isocyanate formulation;
(d) adding the mixture of step (c) or the one or more benzyl ether-type phenolic resin(s) and the isocyanate formulation separately from each other to the provided granular substance and producing a coating on the granular substance;
(e) curing the coating; and
(f) optionally repeating steps (d) and (e).

In a further aspect the above-mentioned binder is used for coating a granular substance, which is selected from agrochemicals.

### DETAILED DESCRIPTION

The coated granular substance according to the present invention comprises a granular substance (hereinafter also referred to as “the granular substance to be coated”) which is coated with a cured binder.

### Granular Substance

The granular substances to be coated are not particularly limited if they are agrochemicals. They may be selected from the agrochemicals known in the technical field. Basically, all granular agrochemicals may be coated by means of the coating system according to the invention. The granular substance may, e.g., be selected from asymmetrically shaped granular substances (granules) or symmetrically shaped substances (pellets). Typical pellets may, e.g., have the shape of a sphere, a rod, a cylinder, or an ellipsoid. Typical granules include asymmetrical aggregates of powder particles, whole crystals, crystal fragments or particles or other fragments. The granular substance may be porous or non-porous.

The grain size of the granular substances to be coated is not critical, either. It may, e.g., be from about 0.1 mm to about 15 mm (average longest diameter), an average grain size within the range of about 1 mm to about 10 mm being preferred.

The granular substances to be coated are preferably at least partially water-soluble. Thus, the granular substances to be coated may also contain water-insoluble components. The solubility of the water-soluble components of the granular substance in water at 20° C. is preferably at least about 10 g/liter, more preferably at least about 30 g/liter and particularly preferred at least about 100 g/liter. Preferably, the granular substances to be coated completely consist of water-soluble components.

The granular substances are agrochemicals, such as fertilizers, plant protection agents, pesticides (including insecticides, herbicides, fungicides, bactericides, akaricides, molluscicides, nematicides, rodenticides, avicides), growth regulators, trace elements, soil improving agents, nitrification inhibitors, urease inhibitors, pheromones, repellents against animals and insects, and mixtures. Preferred granular substances are fertilizers and trace elements, especially fertilizers. Preferably, the granular substance comprises the above-mentioned agrochemicals or the granular substance consists of the above-mentioned agrochemicals. In the present invention, very highly hygroscopic substances may also be used as the granular substance to be coated, e.g., desiccants such as phosphorous pentoxide or calcium chloride. By means of the coating, too rapid dissolution in humid environment may be avoided. Preferred granular, at least partially water-soluble substances are fertilizers.

Fertilizers which are suited for coating include known granules or pellets of organic and mineral fertilizers as well as mixtures thereof. Single- or multi-nutrient fertilizers may, for example, be taken into consideration, which individually or in combination contain nutrients such as nitrogen, potassium or phosphorus in the form or their salts or oxides. Examples thereof are N-, NP-, NK-, PK-, or NPK-fertilizers, such as calcium ammonium nitrate, ammonium sulphate, ammonium sulphonitrate, calcium cyanamide, ammonium nitrate or urea. Along with the above main constituents, salts of trace elements such as magnesium, iron, manganese, copper, molybdenum and/or boron may also be contained in the fertilizer granules in small amounts, usually in amounts of up to about 5 wt.-%, preferably of about 0.5 wt.-% to about 3 wt.-%. Suitable organic fertilizers are for example guano, fish meal, dried cattle manure, or bone meal.

### Coating

The coating comprises a binder which comprises the reaction product of one benzyl ether-type phenolic resin or the more benzyl ether-type phenolic resins and an isocyanate formulation and which was cured.

### Benzyl Ether-Type Phenolic Resin

In the binder at least one benzyl ether-type phenolic resin is employed as a polyol. For simplification, in the following this component is referred to als “benzyl ether-type phenolic resin”. However, it goes without saying that mixtures of several benzyl ether-type phenolic resins are covered by this wording.

All commonly used phenol compounds are suitable for producing the benzyl ether-type phenolic resins. In addition to unsubstituted phenols, substituted phenols or mixtures thereof can be employed. The phenol compounds are preferably unsubstituted either in both ortho-positions or in one ortho- and in the para-position. The remaining ring carbon atoms may be substituted. The choice of substituent is not particularly limited, provided that the substituent does not adversely affect the reaction of the phenol with the aldehyde.

Examples of substituted phenols are alkyl-substituted, alkoxy-substituted, aryl-substituted and aryloxy-substituted phenols.

The basic structure of a benzyl ether-type phenolic resin has —CH₂—O—CH₂-linked phenolic units in addition to —CH₂-linked phenolic units and can be represented exemplarily (with respect to a product reacted with formaldehyde only) as follows

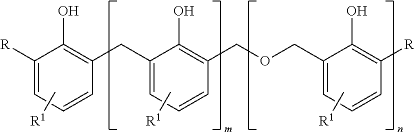

Typically, the different units are statistically distributed (i.e. also linked in a different order than shown above). The phenolic unit can also be partly para-linked. Here, R¹ is each independently (especially from m and n) hydrogen or an alkyl substituent and/or an alkenyl substituent of C1-C26 (saturated or unsaturated, linear or branched) in ortho, meta or para position to the phenolic hydroxy group; the sum of m and n is at least about 2 and the ratio m/n is at least about 1, preferably from about 9:1 to about 1:9 (mol:mol); R independently is hydrogen, —CH₃, —CH₂OH or —CH₂O—R² with R²=a C1 to C9 hydrocarbon. The residue R² can be linear or branched, saturated or unsaturated. In a preferred embodiment, R² is a methyl, ethyl or n-butyl residue or a mixture thereof. From about 5 to about 40 mol %, preferably from about 6 to about 35%, and particularly preferred from about 8 to about 25 mol % of the —CH₂OH groups may be etherified with R².

The above-mentioned substituents have, e.g., 1 to 26, preferably 1 to 15 carbon atoms. Examples of suitable phenols are o-cresol, m-cresol, p-cresol, 3,5-xylenol, 3,4-xylenol, 3,4,5-trimethylphenol, 3-ethylphenol, 3,5-diethylphenol, p-butylphenol, 3,5-dibutylphenol, p-amylphenol, cyclohexylphenol, p-octylphenol, p-nonylphenol, cardanol, 3,5-dicyclohexylphenol, p-crotylphenol, p-phenylphenol, 3,5-dimethoxyphenol and p-phenoxyphenol.

Particularly preferred phenolic components for synthesizing the benzyl ether resin are phenol and/or o-cresol and/or cardanol and/or cardol.

Higher condensed phenols, such as bisphenol A, are also suitable. In addition, polyhydric phenols which have more than one phenolic hydroxyl group are also suitable.

Preferred polyhydric phenols have 2 to 4 phenolic hydroxyl groups. Particular examples of suitable polyhydric phenols are catechol, resorcinol, hydroquinone, pyrogallol, phloroglucin, 2,5-dimethyl resorcinol, 4,5-dimethyl resorcinol, 5-methyl resorcinol, cardol or 5-ethyl resorcinol. Mixtures of various mono- and polyvalent and/or substituted and/or fused phenol components may be used for the production of the polyol.

In one embodiment phenols of the general Formula I

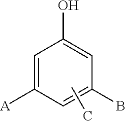

are used for the production of the phenol-formaldehyde resin component, wherein A, B and C are independently from each other selected from: a hydrogen atom, a branched or linear alkyl or alkenyl group, which, e.g., may have 1 to 26, preferably 1 to 15 carbon atoms (wherein the alkenyl group may contain up to 3 conjugated and/or isolated double bonds), a branched or linear alkoxy group, which, e.g., may have 1 to 26, preferably 1 to 15 carbon atoms, a branched or linear alkenoxy group, which, e.g., may have 1 to 26, preferably 1 to 15 carbon atoms (wherein the alkenoxy group may contain up to 3 conjugated and/or isolated double bonds).

The preferred molar ratios of the single structural units in the benzyl ether resin structure are as follows:
phenol to cardanol in the range of about 10:1 to about 99:1, preferably from about 15:1 to about 60:1; and/or
phenol to o-cresol in the range of about 1:1 to about 10:1, preferably from about 1.5:1 to about 3.5:1; and/or
o-cresol to cardanol in the range of about 5:1 to about 30:1, preferably from about 10:1 to about 20:1.

As a further aldehyde for the production of the benzyl ether-type phenolic resins, in addition to formaldehyde also aldehydes of the formula:

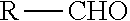

are suitable, wherein R is a carbon atom residue having 1 to 3 carbon atoms, preferably one carbon atom. Specific examples are acetaldehyde and propionaldehyde. The use of formaldehyde is particularly preferred, either in its aqueous form, as para-formaldehyde or trioxane.

In order to obtain benzyl ether-type phenolic resins, preferably an at least equivalent number of moles of aldehyde compound, based on the number of moles of phenolic compounds, is used. The molar ratio of aldehyd compound to phenol compound is preferably from about 1.05:1.0 to about 2.5:1, more preferably from about 1.1:1 to about 2.2:1, particularly preferred from about 1.2:1 to about 2.0:1.

The benzyl ether-type phenolic resin is prepared by methods known to the person skilled in the art. Thereby the phenol and the aldehyde are reacted in the presence of a divalent metal ion at temperatures of preferably at most about 130° C. The resulting water is distilled off. A suitable entraining agent may be added to the reaction mixture, for example toluene or xylene, or the distillation is carried out at reduced pressure.

Catalysts suitable for the production of benzyl ether-type phenolic resins are salts of divalent ions of metals, such as Mn, Zn, Cd, Mg, Co, Ni, Fe, Pb, Ca, and Ba, in particular Zn salts. Zinc acetate is preferably used. The amount employed is not critical. Typical amounts of metal catalysts are about 0.02 to about 0.3 wt.-%, preferably about 0.02 to about 0.18 wt.-%, based on the total amount of phenol compound and aldehyde compound.

Such resins are, e.g., described in U.S. Pat. No. 3,485,797 and in EP 1 137 500, the disclosure of which is hereby expressly referred to both with regard to the benzyl ether-type phenolic resins themselves and with regard to their production. Analyses of these resins show that the weight ratio of free phenol (hydroxybenzene) to free hydroxybenzyl alcohol is always 1: less than 1.

The first reaction step of the formaldehyde addition, consisting of one mol phenol and one mol formaldehyde, forms hydroxybenzyl alcohols, in particular saligenin. Due to the ortho-ortho directing effect of the metal catalyst mainly

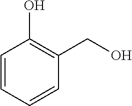

### saligenin (2-hydroxybenzyl alcohol or o-hydroxybenzyl alcohol) Mw:124.14 g/mol

is formed. However, the formation of

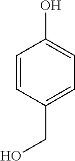

### homosaligenin (4-hydroxybenzyl alcohol or p-hydroxybenzyl alcohol)

is also possible. Mixtures of the positional isomers are also possible, thus the —CH₂—OH group may also be at the ortho- and/or para-position, e.g. may be attached at the ortho- and ortho-, at ortho- and para-, and at ortho-, ortho- and para-position. In a further embodiment one, two or three —CH₂—OH groups may be etherified with a C1 to C9 monohydric alcohol. This monohydric alcohol may be linear or branched, saturated or unsaturated.

What was mentioned for the example phenol is also valid for the phenolic basic bodies o-cresol and m-cresol. Possible mixtures of positional isomers, of the —CH₂—OH group, are located at the ortho- or para- and at the ortho- and para-position. In a further embodiment one or two —CH₂—OH groups may be etherified with a C1 to C9 monohydric alcohol. This monohydric alcohol may be linear or branched, saturated or unsaturated. In a preferred embodiment this is methanol, ethanol or n-butanol.

If cardanol and/or cardol is used as phenolic basic body, the —CH₂—OH group can also be at the ortho- and/or para-position, e.g. may be linked at the ortho- and ortho-, at ortho- and para-, and at ortho-, ortho- and para-position. In a further embodiment one, two or three —CH₂—OH groups may be etherified with a C1 to C9 monohydric alcohol.

This monohydric alcohol may be linear or branched, saturated or unsaturated. In a preferred embodiment this is methanol, ethanol or n-butanol.

Surprisingly, it has now been found that a weight ratio of free phenol to free hydroxybenzyl alcohol in the binder of 1:>1.2 increases the reaction rate of the benzyl ether-type phenolic resin towards isocyanates and reduces the need for an amine catalyst, if present. This makes it possible to reduce the proportion of free CMR substances (CMR=Cancerogen Mutagen Reprotoxic), such as phenol and formaldehyde and thus providing an environmentally friendly alternative.

Monomeric addition products are defined as the first reaction stage of a phenolic basic body with formaldehyde, wherein up to three ring hydrogens of the phenolic basic body may be substituted with a —CH₂—OH group. Monomeric addition products on the basis of phenol have a molar mass of 124 g/mol (hydroxybenzyl alcohol) to 184 g/mol (phenol plus up to 3 —CH₂OH). Any C1- to C26-alkyl groups which are attached to the phenolic basic body and/or attached as an alkyl group to an etherified —CH₂—OH group, are not included in the recited molar weights.

The binder contains free phenol and free hydroxybenzyl alcohol, wherein at least about 1.2 parts by weight of free hydroxybenzyl alcohol per 1 part by weight of free phenol is contained in the binder. Preferably 1.2 to about 30, more preferably from about 1.3 to about 20, particularly preferably from about 1.6 to about 15 and most preferably from about 1.8 to about 13 parts by weight of free hydroxybenzyl alcohol per 1 part by weight of free phenol are contained in the binder.

Within the scope of the invention, “hydroxybenzyl alcohol” means ortho-hydroxybenzyl alcohol, meta-hydroxybenzyl alcohol and para-hydroxybenzyl alcohol:

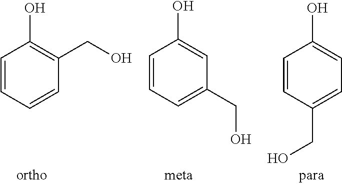

The binder contains free phenol and free saligenin (o-hydroxybenzyl alcohol), wherein at least about 1.1 parts by weight of free saligenin (o-hydroxybenzyl alcohol) per 1 part by weight of free phenol is contained in the binder. Preferred about 1.1 to about 25, preferably from about 1.2 to about 15, particularly preferred from about 1.5 to about 10 and most preferred from about 1.8 to about 8 parts by weight of free saligenin (o-hydroxybenzyl alcohol) per 1 part by weight of free phenol are contained in the binder.

Specifically, weight of the benzyl ether-type phenolic resin means the sum of the weights of the phenolic resin and the related (free) monomers and hydroxybenzyl alcohols, wherein the phenolic resin is the reaction product of at least one formaldehyde compound and a phenol compound, including polymer-analogous reaction products, such as, e.g., alkoxylation of terminal groups.

The content of free phenol is, based on the weight of the benzyl ether-type phenolic resin, preferably at most about 4.0 wt.-%, in particular at most 3.5 wt.-%, more preferably at most about 3.0 wt.-%, even more preferably at most about 2.0 wt.-%.

In one embodiment the binder contains at most about 1.0 wt.-% of free phenol, preferably at most 0.8 wt.-% of free phenol and particularly preferred 0.6 wt.-% of free phenol.

Accordingly, the content of free saligenin (o-hydroxybenzyl alcohol) is, e.g., about 3.5 to about 16.0 wt.-% or about 1.6 to about 12.0 wt.-% and the content of free hydroxybenzyl alcohol is, e.g., about 4.0 to about 26.0 wt.-% or about 2.0 to about 13.0 wt.-%, each based on the weight of the benzyl ether-type phenolic resin.

Accordingly, the content of free saligenin (o-hydroxybenzyl alcohol) is, e.g., about 0.5 to about 10.0 wt.-% or about 0.6 to about 6.0 wt.-% and the content of free hydroxybenzyl alcohol is, e.g., about 0.6 to about 15.0 wt.-% or about 0.8 to about 10.0 wt.-%, each based on the binder.

The benzyl ether-type phenolic resins may contain the required content of free hydroxybenzyl alcohol, in particular free saligenin, either by control during or after the formation reaction of the benzyl ether-type phenolic resin or by the addition of hydroxybenzyl alcohol, in particular saligenin, before, after or during the formation of the phenolic resin, in particular after the formation of the phenolic resin.

It is also possible to control the ratio of free phenol to free hydroxybenzyl alcohol, in particular to saligenin, in the benzyl ether-type phenolic resin by removing the free phenol (or preferably the free phenol) retroactively from the benzyl ether-type phenolic resin, e.g. by steam distillation, azeotropic distillation or leaching with water according to DIN 53704 and, e.g. filtration. If desired, after this step also hydroxybenzyl alcohol, in particular saligenin, may be added. The phenol:saligenin ratio is preferably adjusted by controlling the benzylether resin synthesis.

If, in addition to phenol, further phenolic basic bodies are used, these may each also be present in monomeric form in small amounts, based on the benzyl ether resin. For example, it is possible that in addition to free phenol, the binder additionally contains free cresol and/or cardanol and/or cardol.

The weight average molecular weight (HPLC Agilent 1100, RI Detector, PSS SDV precolumn 5 μm, PSS SDV column 5 μm 1000 Å, PSS SDV column 5 μm 100 Å, fluxing agent THF, column temperature 35° C., calibration against PSS Polystyrene ReadyCal-Kit low (Mp 266-67500 D), internal Standard PSS Polystyrene ReadyCal-Kit low (Mp 266-67500 D)) of the benzyl ether-type phenolic resin without phenol and without monomeric condensation products is preferably from about 350 to about 4000 g/mol, more preferably from about 400 to about 3000 g/mol and particulary preferred from about 500 to about 2000 g/mol.

The OHZ (OH number, determined according to DIN 53240) of the benzyl ether-type phenolic resin can serve as a further characterization, which is preferably from about 500 to about 900 mg KOH/g, particularly preferred from about 550 to about 850 mg KOH/g and most preferred from about 560 to about 750 mg KOH/g.

### Isocyanate Formulation

The isocyanate formulation consists of one or more isocyanate compounds and comprises one or more isocyanate compounds having at least 2 isocyanate groups per molecule.

One or more isocyanate compounds having at least 2 isocyanate groups per molecule may be used as the isocyanate formulation, these may be monomeric, oligmeric or polymeric and have the general formula R(NCO)_{z}, wherein R is a polyvalent organic residue having an aromatic, an aliphatic, a cycloaliphatic or araliphatic residue and z is an integer of at least 2. Examples are ethylene diisocyanate, 1,4-butylene diisocyanate, 1,5-pentane diisocyanate, 1,6-hexamethylene diisocyanate, 1,12-dedecane diisocyanate, cyclobutane-1,3-diisocyanate, cyclohexane-1,3- and 1,4-diisocyanate and mixtures of said isomers, isophorone diisocyanate, 2,4- and 2,6-hexahydrotoluylene diisocyanate and mixtures of said isomers, 2,2,4- and/or 2,4,4-trimethylhexamethylene diisocyanate, bis(4,4′,2,4′ and 2,2 isocyanato-cyclohexyl)methane or mixtures of said isomers, 1,3-diisocyanato-o-xylene an mixtures of further xylene isomers, m-phenylene diisocyanate, p-phenylene diisocyanate, 2,4-toluylene diisocyanate, 2,2′-diphenylmethane diisocyanate, 2,4′-diphenylmethane diisocyanate, 4,4′-diphenylmethane diisocyanate, oligomeric MDI having at least three aromatic cores, 1,5-naphthaline diisocyanate, 4,4′-biphenylene diisocyanate, 3,3′-dimethyl-4.4 diphenylmethane diisocyanate, 3,3′-dimethyldiphenylmethane-4-4-diisocyanate, triisocyanates, such as 4,4,4′″-triphenylmethane triisocyanate 2,4,6-toluene triisocyanate, tetraisocyanates, such as 4,4-dimethyl-2,2′-5,5′-diphenylmethane tetraisocyanate as well as 1,3- and/or 1,4-bis-(2-isocyanato-pr-2-yl)-benzene (TMXDI) and 1,3-bis-(isocyanatomethyl)benzene (XDI).

The NCO content of the used polyisocyanate is at least 17 wt.-%, preferably more than 27 wt.-% and particularly preferred more than 30 wt.-%. The viscosity (25° C., according to DIN 53019-1) of the isocyanate should be <1000 mPas, preferably <700 mPas and particularly preferred <450 mPas.

Depending on the desired properties mixtures of isocyanates may also be used.

The isocyanates may also be derivatized by reacting divalent isocyanates with each other such that a part of their isocyanate groups are derivatized to biuret, allophanatate, uretdione, isocyanurate, carbodiimide, urethone imine groups. Dimerisation products containing uretdione groups, e.g. of MDI or TDI, for example, are of interest. Such derivatized isocyanates are preferably used, however only as one component in addition to the above-mentioned non-derivatized isocyanates.

Furthermore, also blocked isocyanates and/or monoisocyanates may be contained in the isocyanate formulation, wherein as a general rule the amount should not exceed 10 wt.-%, based on the weight of the isocyanate formulation.

The ratio of the isocyanate reactive groups (i.e. the sum of the OH, SH, epoxy and NH₂ groups) to isocyanate groups in the binder is usually chosen in such a way that the molar ratio of isocyanate reactive groups to isocyanate groups is about 1.5:1 to about 1:1.5, preferably about 1.3:1 to about 1:1.3, more preferably about 1.2:1 to about 1:1.2. Practice has shown that a ratio of about 1:1 does not necessarily yield the best result for later application. When looking at the process under the aspect of stoichiometry, if applicable, the isocyanate-reactive functional groups of the catalyst have to be taken into consideration as well.

In a preferred embodiment the binder contains, based on the total weight of the binder:
about 8 to about 70 wt.-%, in particular about 10 to about 62 wt.-%, benzyl ether-type phenolic resin; and/or
about 13 to about 78 wt.-%, in particular about 17 to about 70 wt.-%, of isocyanate formulation.

Depending on the desired properties of the final product, the coated granular substance contains about 0.5 wt.-% to about 30.0 wt.-%, preferably from about 0.5 wt.-% to about 25.0 wt.-%, and particularly preferably from about 0.5 wt.-% to about 20.0 wt.-% of coating, based on the weight of the granular substance without coating. It goes without saying that the weight given refers to the weight after curing.

### Solvent

The benzyl ether-type phenolic resin or the isocyanate formulation of binder system, respectively, may preferably be employed as a solution in an organic solvent or a combination of organic solvents. Solvents may be employed, for example, to keep the components of the binder in a sufficiently low-viscosity state. This is desired, among other things, to achieve a uniform coating of the granular substance and its flowability.

### Inert Solvents

The solvents may be inert solvents. Inert solvents are solvents which cannot be directly incorporated into the polyurethane network, i.e. these are free of hydroxyl, mercaptan, epoxy, amino and isocyanate groups. Suitable solvents are polar and/or non-polar solvents or mixtures thereof. Suitable solvents are, e.g., aromatic solvents known as Solvent Naphtha. Starting from benzene, alkyl and/or alkenyl groups are substituted independently to each other at the aromatic ring, the alkyl- and/or alkenyl groups having a chain length of C1 to C30, preferably of C1 to C20 and particularly preferably of C1 to C16. One to six ring hydrogens of the benzene may independently of each other be substituted against an alkyl and/or alkenyl group, preferably 1 to 4, particularly preferred 1 to 3 ring hydrogens are substituted. Independently, the alkyl or alkenyl chain may be linear or branched.

Furthermore, oxygen-rich organic solvents may be employed. Mainly suitable are dicarboxylic esters, glycol ether esters, glycol diesters, glycol diethers, cyclic ketones, cyclic esters (lactones), cyclic carbonates, fatty acid esters, triglycerides, acetals, semi-acetals or silicic acid esters or their mixtures. Based on the binder 0 to about 15 wt.-% inert solvents, preferably 0 to about 12 wt.-% and most preferred 0 to about 5 wt.-% solvent may be contained. In a preferred embodiment the binder does not contain inert solvents.

When the benzyl ether-type phenolic resin is employed with an inert solvent in the coating, 0 to about 15 wt.-% of inert solvents, preferably 0 to about 12 wt.-% and more preferably 0 to about 5 wt.-% of inert solvent, based on the benzyl ether-type phenolic resin, may be employed. In a preferred embodiment the benzyl ether-type phenolic resin is added without inert solvent.

When the isocyanate formulation is employed with an inert solvent in the coating, 0 to about 15 wt.-% of inert solvent, preferably 0 to about 12 wt.-% and most preferably 0 to about 5 wt.-% of inert solvent, based on the isocyanate formulation, may be employed. In a preferred embodiment the isocyanate formulation is added without inert solvent.

### Reactive Solvents

The binder may contain at least one reactive solvent. A reactive solvent is a solvent which can at least partially be incorporated into the polyurethane network. Reactive solvents contain primary or secondary hydroxyl and/or mercaptan and/or amino groups. The reactive solvent is not a benzyl ether-type phenolic resin and not an isocyanate compound having at least 2 isocyanate groups per molecule and not a mixture of these. Compounds having hydroxyl groups as reactive solvent are preferably employed. Preferably, a reactive solvent is employed with the benzyl ether-type phenolic resin.

Suitable reactive solvents containing hydroxyl groups are hydroxy-functional polyethers, which can be obtained by alkoxylation (with ethylene oxide, propylene oxide or butylene oxide) of polyhydric alcohols, such as glycerol, glycols, trimethylolpropane, sorbitol, sucrose or pentaerythritol. Aminic compounds, such as ethylenediamine and triethanolamine, or mixtures thereof can also serve as starter molecules. Also suitable are polyhydroxy polyesters, which are accessible by esterification of polyvalent carboxylic acids or their anyhdrides with polyvalent alcohols. Furthermore, compounds from the classes of polyetherester polyols, polycarbonate polyols, polycaprolactone diols, polylactides, hydroxy-functional polybutadienes, acrylate polyols, polysiloxane polyols and urea resins may be employed as reactive solvents. The above-mentioned compounds contain 2 to 8 aliphatic hydroxyl groups and have a Brookfield viscosity (25° C.) of >200 mPas.

Preferably, reactive solvents on the basis of renewable raw materials are used. These contain full or partial esters of glycols (including polyglycols such as diglycols and triglycols), trimethylol propane, neopentyl glycol, pentaerythritol, dipentaerythritol, glycerol or polyglycerol with saturated or unsaturated, also polyunsaturated fatty acids of C8-C22. The fatty acids naturally contain hydroxyl groups (such as castor oil fatty acid) or the hydroxyl groups are obtained by ring opening of previously epoxidised double bonds of the fatty acids with water or lower alcohols with C1-C8. Castor oil or Merginols of the company Hobum are mentioned here.

The reactive solvents contain 1.5 to 8 primary and/or secondary hydroxyl groups, preferably 2-8 primary and/or secondary hydroxyl groups per molecule. Preferably, the reactive solvents have a Brookfield viscosity (25° C.) of 300 mPas to 20 Pas, particularly preferred of 400 mPas to 18 Pas, especially lower than the benzyl ether-type phenolic resin. The OHZ (OH number, determined according to DIN 53240) of the reactive solvent can serve as a further characterization, which is preferably from about 150 to about 900 mg KOH/g, particularly preferred from about 200 to about 850 mg KOH/g and most preferred from about 250 to about 750 mg KOH/g.

For adjusting the viscosity low-viscosity, reactive solvents may be used, if necessary. These contain one or two primary or secondary hydroxyl groups and have a viscosity (25° C.), measured by means of a Brookfield-viscometer, of less than 300 mPas. Suitable are monohydric alcohols having a hydroxyl groups and a saturated or unsaturated, linear or branched C-chain of C2-C36, such as ethanol, ethyl hexanol, oleyl alcohol, guerbetal alcohols or dimer diols.

Furthermore, glycols (including polyglycols) with a C-chain of 2-8, with a linear or branched C-chain, glycerol, castor oil fatty acid monoesters, and diols having a C-chain of 3-10, with a linear or branched C-chain, containing primary or secondary hydroxyl groups may be used as reactive solvents. Also suitable are aromatic compounds, based on alkyl and/or alkenyl phenols and/or alkyl and/or alkenyl resorcinols having a saturated or unsaturated, also polysaturated C-chain of 1-26, preferably 2-15. The alkyl and alkenyl chains may be positioned at any position of the phenolic basic body, preferably the ortho and/or para and/or meta position, particularly preferred the meta position. Cardanol and cardol are most preferred.

Particularly preferred solvents are castor oil and/or cardanol and/or cardol and/or and/or castor oil fatty acid ester and/or glycols.

The amounts of reactive solvents employed are not particularly limited. The amounts of the inert and reactive solvents together with the benzyl ether-type phenolic resin discussed above result in a polyol formulation. Reactive solvents are contained in the polyol formulation preferably in an amount of about 10 to about 90 wt.-%, preferably about 20 to about 70 wt.-%, based on the polyol formulation. Preferably, the polyol formulation contains from about 10 to about 45 wt.-% of a benzyl ether-type phenolic resin and from about 20 to about 90 wt.-% of a reactive solvent. Particulary preferred, the polyol formulation contains from about 15 to about 45 wt.-% of a benzyl ether-type phenolic resin, from 0 to about 15 wt.-% of free cardanol, from about 30 to about 60 wt.-% of castor oil and no inert solvent.

Particulary preferred, the polyol formulation contains from about 10 to about 25 wt.-% of a benzyl ether-type phenolic resin, from 0 to about 10 wt.-% of free cardanol, from about 15 to about 30 wt.-% of castor oil and no inert solvent.

The content of free phenol in the polyol formulation is preferably less than 3.0 wt.-% and more preferably less than 1.0 wt.-%.

The content of free phenol in the binder is preferably less than 1.5 wt.-% and particularly preferred less than 0.5 wt.-%. Reactive solvents are preferably present in an amount of from about 5 to about 45 wt.-%, preferably from about 10 to about 35 wt.-%, based on the binder.

Preferably, the binder contains from about 5 to about 25 wt.-% of a benzyl ether-type phenolic resin and from about 10 to about 45 wt.-% of a reactive solvent.

### Curing Agent

Catalysts known in the field of polyurethane coating may be employed for curing the binder. Examples include amine catalysts and metal catalysts, whereas amine catalysts are preferred. The amine catalysts may be both those substances which may react into the resin and those the chemical structure of which does not allow them to do so.

As the amine catalysts, basically all amino-functional substances such as aliphatic, cycloaliphatic, heterocyclic and/or aromatic amines may be used. Both primary, secondary and tertiary monoamines as well as polyamines having primary, secondary and tertiary amino groups may be used. These may be used in liquid form, as a spray or in a gaseous aggregate state. Furthermore, also combinations of liquid and gaseous amine addition may be used. Mixtures of the individual amines with each other are also possible.

Non-limiting examples of liquid amine catalysts are triethanolamine, dimethylethanolamine, vinylimidazole, 2-(2-dimethylaminoethoxy)ethanol, 1,3-propanediamine, 3′-iminobis(N,N-dimethylpropylamine), tetramethylguanidine, N,N,N′-trimethylaminoethyl-ethanolamine 4,4-phenylpropylpyridine, 1,3,5-tris(3-(dimethylamino)propyl)-hexahydro-s-triazine, 2,2′-dimorpholinodiethylether, N-methylmorpholine, N-ethylmorpholine, benzenedimethylamine, N,N-dimethylcyclohexylamine, pentamethyldiethylenetriamine, N,N,N′,N″,N″-pentamethyl-dipropylenetriamine, bis-(2-methylaminoethyl)ether, diazabicyclooctane, and N,N-diisopropylamine. A general definition can, for example, be derived from the following structure, in which only the catalytically active centres are shown:

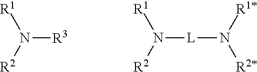

wherein R¹, R², R³, R¹* and R²* independently from each other are selected from H, C6-C12 aryl, C1-C18 alkyl, C1-C18 alkylene-C6-C12 aryl, C1-C8 alkylene-O-C1-C8 alkyl, C1-C8 alkylene-O-C1-C8 alkyl-OH, C2-C18 alkenyl, C1-C18 hydroxyalkyl, C2-C18 hydroxyalkenyl, C1-C18 aminoalkyl, C2-C18 aminoalkenyl, C6-C12 aminoaryl, C5-C18 cycloalkyl, C5-C18 cycloalkenyl, C1-C18 aminoalkyl alcohol, C1-C18 alkylaminoalkyl alcohol, C2-C18 aminoalkenyl alcohol and C6-C12 aminoaryl alcohol. In a further embodiment R¹ and R² or R¹* and R²*, respectively, may be joined to form a ring having 3 to 10 ring atoms, wherein the ring atoms (except from the N of the amine) are selected from C, N, O and S. Preferred amine catalysts are compounds of the above-mentioned structural formula, wherein R¹, R², R³, R¹* and R²* independently from each other are selected from H, C1-C18 alkyl, C1-C18 hydroxyalkyl, C1-C18 alkylene-C6-C12 aryl and C5-C18 cycloalkyl or compounds, in which R¹ and R² or R¹* and R²* are joined to form a ring. Particularly preferred are compounds, in which R¹, R², R³, R¹* and R²* independently from each other are selected from H, C1-C18 alkyl, and C1-C18 hydroxyalkyl.

L is selected from C1-C12 alkylene, C1-C6 alkylene-O-C1-C6 alkylene, C1-C6 alkylene-NH-C1-C6 alkylene, C1-C6 alkylene-N(C1-C6 alkyl)-C1-C6 alkylene, and —C(═NH)—. Preferably, L is selected from C1-C12 alkylene. Gaseous amines are amines which can be evaporated by flowing through and/or vaporising a carrier gas (usually air or an inert gas). Depending on the boiling point and the vapor pressure of the amine, this may take place at about +10° C. to about +120° C. In general, the vaporizable amines have a boiling point of less than about 95° C. (1013 mbar). These are, for example, trimethylamine, triethylamine, dimethylethylamine, dimethylpropylamine and Dimethylisopropylamine or mixtures thereof.

In a preferred embodiment the amines employed are N,N,N′-trimethylaminoethylethanolamine, dimethylethanolamine, dimethylisopropylamine or mixtures thereof.

Furthermore, blocked amines may be used. These have the advantage of a “switching temperature” and only start the reaction at a certain temperature. Formic acid, for example, can be considered as a blocking agent.

Such blocked amines are, for example, known from WO 2011/095440 and comprise the products Toyocat DB 30, Toyocat DB 40, Toyocat DB 41, Toyocat DB 60 and Toyocat DB 70, which are commercially available fromTosoh Corporation, Tokyo. These products differ in terms of application by the degree of their thermolatency.

Curing can also be carried out exclusively with metal catalysts.

As the metal catalysts, basically the organic or inorganic salts of the elements tin, bismuth, iron, zinc, preferably in combination with organic carboxylates, are suitable. Among the suitable metal catalysts, the following examples shall be mentioned: dibutyltin laurate, dioctyltin dilaurate, dioctyltin acetate, zinc neodecanoate, iron(II)chloride, iron(III)chloride, zinc chloride, and bismuth octoate.

In order to achieve specific curing properties, two or more catalysts, which may belong to different classes of compounds, may also be mixed. Different curing methods can also be combined. In order to increase activity, one or more catalysts may additionally be added to the benzyl ether-type phenolic resin and/or the isocyanate formulation, whereby they may belong to different compound classes.

Catalysts which are liquid or solid at the operating temperature may be admixed with suitable inert and/or reactive solvents, e.g., to influence the reaction rate in this manner. This can be used to convert amines which are solidat operating temperature into the liquid state.

The exact amount of the catalyst depends on the kind of catalyst and may be suitably chosen by a skilled person. The amount of catalyst required to cure the benzyl ether-type phenolic resin and the isocyanate formulation depends on the reactivity of the binder, the desired curing time, and the operating temperature. In an amine catalyst generally from about 0.05 wt.-% to about 20 wt.-% are employed, preferably from about 0.1 to about 10 wt.-% and particularly preferred from about 0.15 to about 6 wt.-%, based on the total amount employed from the amount of the benzyl ether-type phenolic resin and the amount of the isocyanate formulation.

In case the reaction rate for producing the coated granular substance is not of relevance, the benzyl ether-type phenolic resin and the isocyanate formulation may be applied and cured without adding a catalyst.

To extend the pot life, common reaction retarders such as phosphorus oxychloride, phenylphosphonic acid dichloride, salicylic acid or phosphoric acid half esters can be added to the binder, if desired.

### Optional Additives

The coating may contain additives, if necessary. These can be, among others, active plant substances that should be specifically present in the coating and not in the granular substance. These active agents are for example trace elements such as, e.g., boron, copper, manganese, zinc, magnesium, calcium, iron, cobalt, and molybdenum.

In order to avoid undesirable formation of bubbles during the side-reaction of the isocyanates with traces of water, optionally other further common additives such as desiccants (for example zeolites or other molecular sieves, or ortho-formic acid esters), wetting agents such as, e.g., surface-active agents, levellingl agents such as, e.g., silicone-based additives like polysiloxanes or silicone additives, waxes, processing time regulators such as, e.g. acids and alkalis, or hydrophobing agents, such as, e.g., waxes, anti-foaming agents and deaerators may optionally be added. Likewise, it is possible to add pigments and/or color pastes in order to highlight the coating in color.

### Method for Coating a Granular Substance

The present invention further refers to a method for producing a coated granular substance according to the invention, comprising the steps:
(a) providing the granular substance;
(b) providing the benzyl ether-type phenolic resin and the isocyanate formulation;
(c) optionally mixing the benzyl ether-type phenolic resin with the isocyanate formulation;
(d) adding the mixture of step (c) or the benzyl ether-type phenolic resin and the isocyanate formulation separately from each other to the provided granular substance and producing a coating on the granular substance;
(e) curing the coating; and
(f) optionally repeating steps (d) and (e).

In step (d) the benzyl ether-type phenolic resin and the isocyanate formulation are brought into contact with the granular substance in order to produce a coating on the granular substance. In one embodiment the benzyl ether-type phenolic resin and the isocyanate formulation are pre-mixed. The mixture is then brought into contact with the granular substance. In another embodiment, the benzyl ether-type phenolic resin and the isocyanate formulation are added separately from each other to the granular substance. Here the benzyl ether-type phenolic resin and the isocyanate formulation can be added simultaneously or successively in any order. Combinations of both embodiments are also possible.

The coating can be performed most easily in a rotating drum in which the material to be coated is kept in motion during the entire coating process. The benzyl ether-type phenolic resin and the isocyanate formulation are added to the material to be coated as a premix or separately, simultaneously or subsequently and are preferably homogenously distributed thereon. Among others, the following variations are possible:
a) adding the premix of benzyl ether-type phenolic resin and isocyanate formulation;
b) adding the benzyl ether-type phenolic resin and subsequently adding the isocyanate formulation;
c) adding the isocyanate formulation and subsequently adding the benzyl ether-type phenolic resin; and
d) simultaneously adding the benzyl ether-type phenolic resin and the isocyanate formulation without prior mixing.

In case plant additives are to be incorporated into the coating, these may be charged prior to, during or after the addition of the binder.

Instead of a rotating drum, other coating systems may be chosen as well, such as fluidized bed systems or tubular apparatuses in which the coating is either performed by rotating the tube and/or by rotating components. Likewise, a continuous coating process using a screw conveyor may be used.

The “operating temperature” is the temperature at which steps (d) and (e) are performed. The operating temperature is preferably from about 10° C. to about 160° C., more preferably from about 15° C. to about 100° C., and particularly preferably from about 20° C. to about 95° C.

If required, the coating procedure can be carried out under reduced pressure and/or in an inert gas atmosphere.

The catalyst may be introduced into the mixture in liquid form, as an atomized spray as well as in a gaseous aggregate state, as soon as the resin and optionally the additives are homogenously distributed on the substance to be coated. The residence time until the catalyst is added depends on the effectiveness of the mixing unit, the operating temperature, the amount of material to be coated and the amount of resin as well as the amount of optional additives. The residence time is preferably from about 0 seconds to about 5 minutes, particularly preferably 0 to about 3 minutes.

The application of the resin in the amount required for later use may either be performed in one step or the coating may be applied in layers in several partial steps, each partial layer being cured separately. In this way of proceeding, it is, however, not necessary to wait until the underlying layer is completely cured before a further partial layer is applied. It may even be advantageous to apply the respective subsequent partial layer at a point in time at which the previous layer is only partially cured and, thus, there is still the possibility of the layers forming a composite. If the coating has a layered structure, it is conceivable that the individual partial layers consist of resins of different compositions and/or that additives are purposefully incorporated into one specific layer, e.g., the outermost layer.

The coating process may be performed both in a batchwise and in a continuous manner. The latter may, for example, be the case because in a tubular apparatus, one or more regions for the addition of the resin and optional plant additive are arranged in an alternating manner with one or more regions for the addition of the catalyst. All individual steps, i.e. the addition of the uncoated granular substance, the transport from one region to the next, charging the resin, charging the optional additives as well as the catalyst and discharge of the finished final product may take place continuously in such a system, so that no time is lost by emptying and refilling the system.

Other embodiments of batchwise or continuously working coating systems are not excluded by the above brief description.

The coated granular substance according to the invention is preferably obtainable in accordance with the above described method according to the invention for coating a granular substance. More preferably, the coated granular substance according to the invention is obtained in accordance with the method according to the invention, wherein the catalyst for curing the compound is added in step (e), and particularly preferably the catalyst is added in step (e) in liquid form or in gaseous form.

The following examples illustrate the invention without restricting it.

### Examples

### Chemicals Used:

| | |
|---|---|
| Phenol (99%) | Sigma Aldrich |
| cardanol (mixture of about 95% | Cardolite |
| cardanol and 5 cardol) | |
| castor oil, refined, technical | Alberdingk & Boley |
| castor oil methyl ester | Sigma Aldrich |
| Lupranat M 20 S (polymeric MDI, | BASF SE |
| functionality 2.6) | |
| dimethylisopropylamine | Sigma Aldrich |
| N,N,N′-trimethylaminoethylethanole | Huntsman |
| amine | |
| saligenin (o-hydroxybenzyl | Sigma Aldrich |
| alcohol) | |
| quartz sand H 32 | Quarzwerke GmbH |
| (grain size ≤ 0.5 mm) | |

Benzyl ether resin 1 (phenol/cardanol copolymer) according to Example 1 of DE 10158693 A1, characterized by the following analytical classification numbers:
molecular weight (Mn) 434 g/mol, molecular weight (Mw) 1987 g/mol, molecular weight (Mz) 6255 g/mol
OHZ: about 580 mg KOH/g
content of free phenol: 11.8 wt.-%
content of free saligenin: 7 wt.-%
ratio free phenol: free saligenin=1:0.6

Benzyl ether resin 2 (o-cresol/phenol/cardanol copolymer) characterized by the following analytical classification numbers:
molecular weight (Mn) 525 g/mol, molecular weight (Mw) 1400 g/mol, molecular weight (Mz) 3570 g/mol
OHZ: about 560 mg KOH/g
content of free phenol: 1.8 wt.-%
content of free saligenin: 3.8 wt.-%
ratio free phenol: free saligenin=1:2.1

Benzyl ether resin 3

In a reaction vessel equipped with a stirring device, a reflux condenser and a thermometer 648.4 phenol (99%), 352.6 g paraformaldehyde (91%) and 0.6 g zinc acetate dihydrate were provided. The temperature was uniformly increased to 105 to 115° C. within 60 minutes under stirring and maintained until a refractive index (25° C.) of 1.5590 was reached. Then 50 g of cardanol were added, the condenser was changed to atmospheric distillation and the temperature was brought to 120-125° C. within one hour. The distillation was continued at this temperature until a refractive index (25° C.) of 1.5940 was reached. Then a vacuum was applied and distillation was carried out at reduced pressure to a refractive index (25° C.) of about 1.6020. Subsequently, for every 90 parts by weight of the resin obtained, 8 parts by weight of n-butanol and 2 parts by weight of water were added and kept under reflux at 100 to 112° C. for 60 minutes. The unreacted butanol was then removed under vacuum. The resin had a refractive index (25°) of about 1.5980. The content of free phenol, determined by means of GC, was 3.8 wt.-%, the content of free saligenin was 6.7%.

Ratio free phenol:free saligenin=1:1.76

### Polyol Formulation (Given in Parts by Weight)

TABLE 1

| | Comparison | | According to the invention | | | | |
|---|---|---|---|---|---|---|---|
| | A1 | A2 | B1 | B2 | B3 | B4 | B5 |
| Benzyl ether resin 1 | 25 | | | | | | 17 |
| Benzyl ether resin 2 | | 22.5 | 25 | 25 | 25 | | |
| Benzyl ether resin 3 | | | | | | 25 | |
| Phenol | | 2.5 | | | | | |
| Cardanol | | | | 5 | | | |
| Saligenin | | | | | | | 8 |
| Castor oil | 75 | 75 | 75 | 70 | 70 | 75 | 67 |
| Castor oil methyl ester | | | | | 5 | | |
| P/S ratio | 1:0.6 | 1:0.29 | 1:2.1 | 1:2.1 | 1:2.1 | 1:1.76 | 1:4.6 |
| free phenol | 2.95% | 2.95% | 0.45% | 0.45% | 0.45% | 0.95% | 2.00% |

The polyol formulation A2 was adjusted so that both, A1 as well as A2 have a free content of monomeric phenol of 2.95%.

P/S ratio: ratio of free phenol:free saligenin, based on the poloyl formulation

Free phenol: amount of free phenol, based on the polyol formulation.

### Determination of Reactivity

### Curing by Gaseous Amine

To 100 parts by weight (GT) of quartz sand H 32, 0.6 GT of each of the polyol formulations A1-B5 and 0.6 GT of Lupranat M 20 S were added in succession and intensively mixed in a laboratory mixer (company Vogel und Schemmann AG). After mixing the mixture for 2 minutes, the sand mixtures were transferred into the storing tank of a core shooter (company Roperwerke Gießereimaschinen GmbH) and from there introduced by means of compressed air (4 bar) into a cylindrical mould of 300 mm length and 50 mm diameter. Subsequently, 2.0 ml of liquid dimethylisopropylamine was injected into the rinsing tube by means of a syringe and the amine/air mixture was passed through the mould at 2 bar pressure for 60 seconds. Immediately after rinsing the mould was opened and the portion of uncured moulding material was removed and weighed. Afterwards, it was determined by weighing how much moulding material mixture had been cured by the specified amount of amine.

TABLE 2

| Polyol formulation | Uncured sand | Cured sand |
|---|---|---|
| A1 (Comparison) | 455 g | 1526 g |
| A2 (Comparison) | 347 g | 1637 g |
| B1 (according | 187 g | 1796 g |
| to the invention) | | |
| B2 (according | 195 g | 1788 g |
| to the invention) | | |
| B3 (according | 190 g | 1784 g |
| to the invention) | | |
| B4 (according | 178 g | 1774 g |
| to the invention) | | |
| B5 (according | 165 g | 1760 g |
| to the invention) | | |

Table 2 shows the determined mass fractions of cured and uncured sand obtained by means of gaseous amine gassing.

Table 2 indicates that the binders according to the invention show a more effective curing by about 10% to 12% in the same gassing time with an identical amount of amine.

### Curing by Means of Spray Application

1.0 kg of commercial NPK fertilizer (16-10-17, 2-4 mm average grain size) preheated to 69-72° C. was filled into a coating drum (without fittings/crushers) and kept in constant motion by rotating the drum (30 rpm). For each coating process, 10 g of polyol formulation was homogeneously premixed with 10 g of Lupranat M 20 S in a paper cup. This mass was evenly applied to the rotating fertiliser granulate over 30 seconds. Using an airless gun, 0.30 ml of liquid catalyst (N,N,N′-trimethylaminoethylethanolamine) was sprayed evenly onto the moving surface. After completion of the spraying process (duration about 20 seconds), the time from when the granulate starts to move freely again in the drum was measured. As soon as the granulate flowed freely the coating and spraying process was repeated. Three coating and spraying courses were carried out in total, the fourth coating process was cured without an applied catalyst—only with the residual catalyst present.

TABLE 3

| Polyol formulation | 1 | 2 | 3 | 4 (without catalyst) | Sum |
|---|---|---|---|---|---|
| A1 | 09:31 | 00:42 | 00:18 | 16:00 | 26:31 |
| A2 | 07:30 | 00:41 | 00:10 | 9:20 | 17:41 |
| B1 | 07:40 | 00:10 | 00:02 | 1:00 | 8:52 |
| B2 | 07:56 | 00:12 | 00:02 | 1:30 | 9:40 |
| B3 | 07:52 | 00:14 | 00:02 | 1:10 | 9:18 |

Table 3 depicts the curing times of the individual coating processes or the sum of these in (minutes:seconds) after feeding the liquid catalyst until the granulate was free flowing again.

It can be taken from the Table that a significantly faster curing is achieved by the binder according to the invention (Example A1 and A2 to B1 to B3), in particular after the second coating step. The time for utilisation of the residual catalyst still applied to the granulate from the previous coating steps is also reduced.

### Leaching Tests

10 g of the above prepared and at least 24 h old fertilizer granules were added to 850 ml of boiling, deionised (starting conductance 0.9 μS/cm) water. The water contained in the flask was brought to a boil by means of a heating mantle, boiling stones prevented a possible superheating and a reflux condenser prevented evaporation. After determined times the conductivity was measured by means of a conductivity meter with temperature compensation. The temperatures of the leachings and measurements were between 90° C. to 95° C. Data given in μS/cm.

TABLE 4

| Polyol | | | | | | | | | |
|---|---|---|---|---|---|---|---|---|---|
| formulation | 0.1 h | 0.5 h | 0.75 h | 1.1 h | 1.5 h | 1.9 h | 2.1 h | 2.5 h | 3 h |
| A1 | 203 | 420 | 800 | 1300 | 2100 | 2900 | 3370 | 3950 | 4500 |
| A2 | 250 | 460 | 850 | 1400 | 2200 | 3100 | 3400 | 4100 | 4600 |
| B1 | 356 | 591 | 900 | 1500 | 2300 | 3200 | 3590 | 4240 | 4700 |

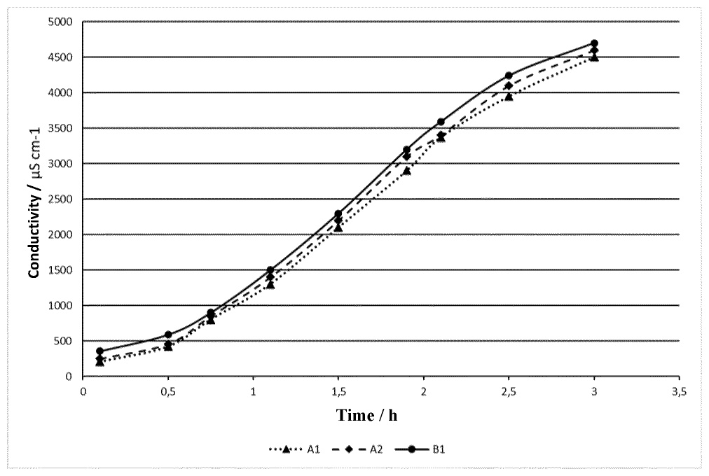

Table 4 shows the conductivity in μS/cm after certain times. The results are also shown in FIG. 1.

It can be seen that the content of free phenol has no significant influence on the release of nutrients from the fertilizer grain.

1. A coated granular substance, wherein the coating is obtained by curing a binder,
wherein the binder comprises:
one or more benzyl ether-type phenolic resins;
an isocyanate formulation consisting of one or more isocyanate compounds, wherein at least one isocyanate compound has at least 2 isocyanate groups per molecule;
wherein the binder is further characterized by one or both of the following features:
a) the binder contains free phenol and free hydroxybenzyl alcohol, wherein at least about 1.2 parts by weight of free hydroxybenzyl alcohol per 1 part by weight of free phenol is contained in the binder;
b) the binder contains free phenol and free saligenin (o-hydroxybenzyl alcohol), wherein at least about 1.1 parts by weight of free saligenin (o-hydroxybenzyl alcohol) per 1 part by weight of free phenol is contained in the binder;
wherein the granular substance is selected from agrochemicals.

2. The coated granular substance according to claim 1, wherein the weight ratio of free phenol to free hydroxybenzyl alcohol in the binder is
1 to greater than 1.2 up to 1 to 30,
preferably 1 to 1.3 up to 1 to 20,
particularly preferred 1 to 1.6 up to 1 to 15, and
most preferably 1 to 1.8 up to 1 to 13.

3. The coated granular substance according to claim 1, wherein the weight ratio of free phenol to free saligenin in the binder is
1 to greater than 1.1 up to 1 to 25,
preferably 1 to 1.2 up to 1 to 15,
particularly preferred 1 to 1.5 up to 1 to 10, and
most preferably 1 to 1.8 up to 1 to 8.

4. The coated granular substance according to claim 1, wherein the binder, based on the weight of the benzyl ether-type phenolic resin, contains at most about 4.0 wt.-% of free phenol, preferably at most about 3.5 wt.-% of free phenol, more preferably at most about 2.0 wt.-% of free phenol.

5. The coated granular substance according to claim 1, wherein the binder contains at most about 0.5 wt.-% of free phenol.

6. The coated granular substance according to claim 1, wherein the binder also contains free cresol and/or cardanol and/or cardol in addition to free phenol.

7. The coated granular substance according to claim 1, wherein the binder contains, based on the total weight of the binder:
about 8 to about 70 wt.-%, in particular about 10 to about 62 wt.-%, benzyl ether-type phenolic resin; and/or
about 13 to about 78 wt.-%, in particular about 17 to about 70 wt.-%, of isocyanate formulation.

8. The coated granular substance according to claim 1, wherein the molar ratio of the isocyanate reactive groups to the isocyanate groups is from about 1.5:1 to about 1:1.5, preferably about 1.3:1 to about 1:1.3, more preferably about 1.2:1 to about 1:1.2.

9. The coated granular substance according to claim 1, wherein the curing is carried out by means of a curing agent, which is selected from aliphatic, cycloaliphatic, heterocyclic and/or aromatic amines.

10. The coated granular substance according to claim 9, wherein the amine is selected from N,N,N′-trimethylaminoethylethanolamine, dimethylethanolamine, dimethylisopropyl-amine and a vaporizable amine having a boiling temperature of at most about 95° C. (at 1013 mbar).

11. The coated granular substance according to claim 1, wherein the curing is carried out completely or partially without a catalyst.

12. The coated granular substance according to claim 1, wherein the weight of the coating is about 0.5 to about 30.0 wt.-%, based on the weight of granular substance.

13. The coated granular substance according to claim 1, wherein the grain size of the granular substance is about 1 to about 10 mm.

14. The coated granular substance according to claim 1, wherein the agrochemical is selected from fertilizers, plant protection agents, pesticides, growth regulators, trace elements, soil improving agents, nitrification inhibitors, urease inhibitors, pheromones, repellents against animals and insects, and mixtures thereof.

15. A method for the production of a coated granular substance according to claim 1, comprising the steps
(a) providing the granular substance;
(b) providing the one or more benzyl ether-type phenolic resin(s) and the isocyanate formulation;
(c) optionally mixing the one or more benzyl ether-type phenolic resin(s) with the isocyanate formulation;
(d) adding the mixture of step (c) or the one or more benzyl ether-type phenolic resin(s) and the isocyanate formulation separately from each other to the provided granular substance and producing a coating on the granular substance;
(e) curing the coating; and
(f) optionally repeating steps (d) and (e).

16. Use of a binder for coating a granular substance,
wherein the binder comprises:
one or more benzyl ether-type phenolic resins;
an isocyanate formulation consisting of one or more isocyanate compounds having at least 2 isocyanate groups per molecule;
wherein the binder is further characterized by one or both of the following features:
a) the binder contains free phenol and free hydroxybenzyl alcohol, wherein at least about 1.2 parts by weight of free hydroxybenzyl alcohol per 1 part by weight of free phenol is contained in the binder;
b) the binder contains free phenol and free saligenin (o-hydroxybenzyl alcohol), wherein at least about 1.1 parts by weight of free saligenin (o-hydroxybenzyl alcohol) per 1 part by weight of free phenol is contained in the binder;
wherein the granular substance is selected from agrochemicals.
